(19) United States
(12) Patent Application Publication
(10) Pub. No.: US 2009/0050381 A1
(43) Pub. Date: Feb. 26, 2009

(54) POWER WHEELCHAIR

(75) Inventor: Ming-Chuan CHENG, Taichung City (TW)

Correspondence Address: BROWDY AND NEIMARK, P.L.L.C.;624 NINTH STREET, NW, SUITE 300, WASHINGTON, DC, 20001-5303, US

(73) Assignee: Merits Health Productions Co., LTD, Taichung (TW)

(21) Appl. No.: 11/956,037

(22) Filed: Dec. 13, 2007

(30) Foreign Application Priority Data
Aug. 23, 2007 (TW) 96131290

(51) Int. Cl. A61G 5/10; A61G 5/04

(52) U.S. Cl. 180/54.1

(57) ABSTRACT

A power wheelchair includes a frame having first and second pivot portions on each of opposite sides of one end thereof, a pair of first wheel sets each having a first wheel mount pivoted to one of the second pivot portions of the frame and a first wheel rotatably connected to the first wheel mount, a pair of driving wheel sets each having a driving wheel mount pivoted to one of the first pivot portions of the frame and a driving wheel rotatably connected to the driving wheel mount, and a pair of suspension devices each connected between the first wheel mount of one of the first wheel sets and the driving wheel mount of one of the driving wheel sets. Thus, the power wheelchair has advantages of stable construction and safety in use.

### BACKGROUND OF THE INVENTION

1. Field of the Invention

The present invention relates generally to a power wheelchair, and more specifically to a power wheelchair that has the advantage of safety in use.

2. Description of the Related Art

FIG. 1 shows a conventional power wheelchair 1 comprising a frame 10, a pair of front wheel sets 11, a pair of middle wheel sets 12 and a pair of rear wheel sets 13. The frame 10 has a pivot portion 102 on left and right sides of a front thereof and a support tube 104 behind the pivot portion 102 for mounting a seat set 14. The front wheel sets 11 each have a front wheel mount 112 pivotally connected to the pivot portion 102 of the frame 10 and a front wheel 114 rotatably connected to the front wheel mount 112. The middle wheel sets 12 each have a middle wheel mount 122 pivotally connected to the pivot portion 102 of the frame 10 and a middle wheel 124 rotatably connected to the middle wheel mount 122. The rear wheel sets 13 each have a rear wheel mount 132 connected to a rear of the frame 10 and a rear wheel 134 rotatably connected to the rear wheel mount 132.

According to this design, the front wheel mounts 112 and the middle wheel mounts 122 are pivoted to the same position, i.e. pivoted to the pivot portions 102 of the frame 10, such that the front wheel mounts 112 and the middle wheel mounts 122 can be pivotable relative the frame 10 when the power wheelchair 1 runs on a rough road.

A user usually steps on a pedal 15 fixed on the front of the frame 10 to sit on or leave the seat set 14 of the power wheelchair 1 such that the pedal 15 is designed to receive the user's whole body weight. If the pedal 15 is received an exceeding weight, the front of the frame 10 may be forced to pivot forwardly about the pivot portions 102 of the frame 10, resulting in that the rear of the frame 10 may be lifted upwardly and the seat set 14 may be overturned. As a result, the user stood on the pedal 15 may fall down or be hurt by the seat set 14. Thus, the conventional power wheelchair 1 is not safe in use and easily causes an accident to the user.

### SUMMARY OF THE INVENTION

The present invention has been accomplished in view of the above-noted circumstances. It is one objective of the present invention to provide a power wheelchair, which has the advantage of safety in use.

To achieve the aforesaid objective of the present invention, the power wheelchair comprises a frame, a pair of first wheel sets, a pair of driving wheel sets and a pair of suspension devices. The frame has first and second pivot portions on each of opposite sides of one end thereof. Each first wheel set has a first wheel mount pivoted to the second pivot portion at one of the opposite sides of the frame and a first wheel rotatably connected to the first wheel mount. Each driving wheel set has a driving wheel mount pivoted to the first pivot portion at one of the opposite sides of the frame and a driving wheel rotatably connected to the driving wheel mount. Each suspension device is connected between with the first wheel mount of one of the first wheel sets and the driving wheel mount of one of the driving wheel sets. The present invention provides the first wheel mount of the first wheel set and the driving wheel mount of the driving wheel set pivoted on the two different pivot portions of the frame, such that the power wheelchair of the present invention has advantages of stable construction and safety in use.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a lateral view of a power wheelchair according to a prior art;

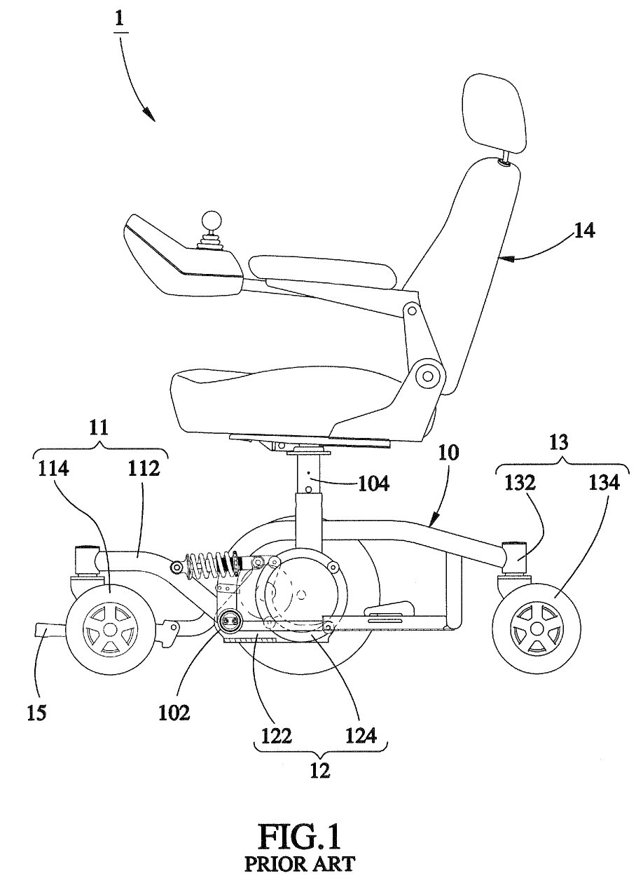

FIG. 2 is a lateral view of a power wheelchair according to a preferred embodiment of the present invention;

FIG. 3 is a partially exploded view of the power wheelchair according to the preferred embodiment of the present invention;

FIG. 4 is a schematic drawing, showing that the first wheels of the power wheelchair of the present invention run on a protrusion, and

FIG. 5 is a schematic drawing, showing that the first wheels of the power wheelchair of the present invention run into a recess.

### DETAILED DESCRIPTION OF THE INVENTION

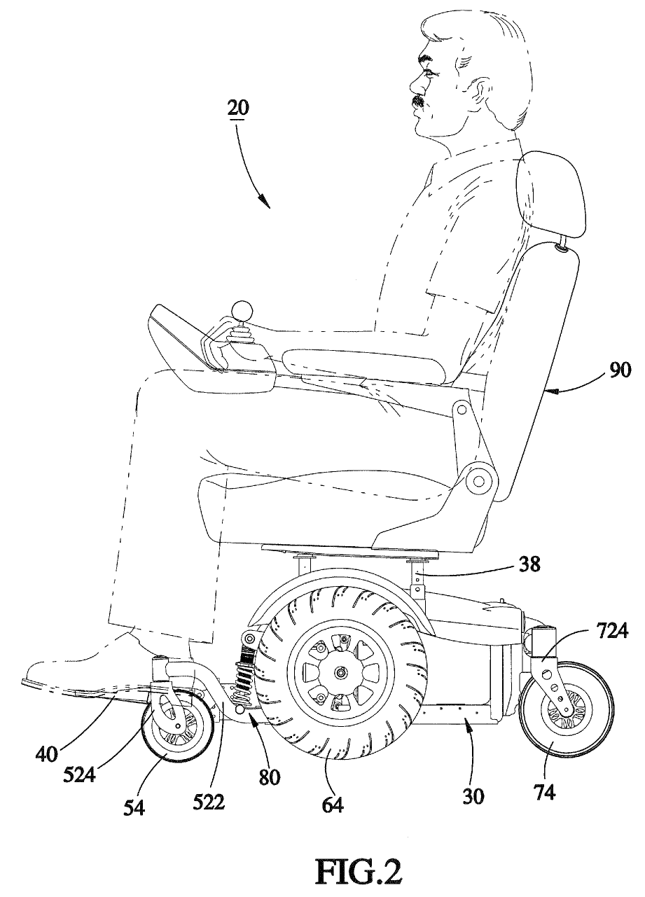

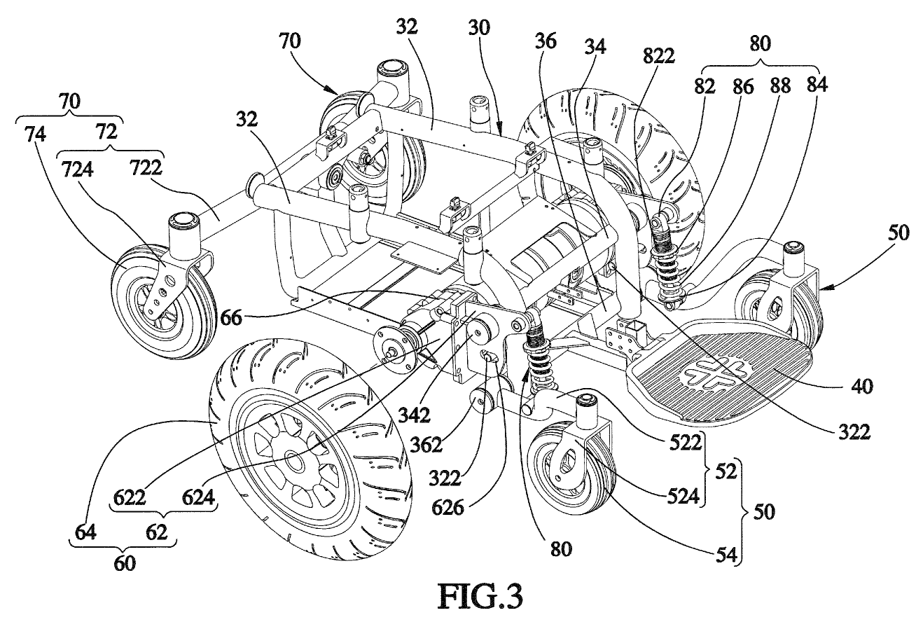

Referring to FIGS. 2 and 3, a power wheelchair 20 in accordance with a preferred embodiment of the present invention comprises a frame 30, a pedal 40, a pair of first wheel sets 50, a pair of driving wheel sets 60, a pair of second wheel sets 70 and a pair of suspension devices 80.

The frame 30 has a lateral bar 32 on left and right sides thereof, two limiting portions 322 respectively fixed on a front of the lateral bar 32 with an end extending out of the lateral bar 32, a first bar 34 fixed on the fronts of the lateral bars 32 with two ends respectively protruding out of the lateral bars 32 to form first pivot portions 342, and a second bar 36 fixed on the fronts of the lateral bars 32 and located under the first bar 34 and having two ends respectively protruding out of the lateral bars 32 to form second pivot portions 362. In addition, the frame 30 further includes a plurality of support bars 38 extending upwardly for mounting a seat set 90.

The pedal 40 is configured to be fixed to a middle of the second bar 36 of the frame 30 so as to locate at a front of the frame 30 for pedaling.

The first wheel sets 50 are front wheel sets in this embodiment, each of which comprises a first wheel mount 52 having a first wheel frame 524 and a first wheel tube 522 with a rear end pivotally mounted to the second pivot portion 362 of the frame 30 and a front end connected to the first wheel frame 524, and a first wheel 54 rotatably mounted to the first wheel frame 524 of the first wheel mount 52.

The driving wheel sets 60 are middle wheel sets in this embodiment, each of which comprises a driving wheel mount 62 and a driving wheel 64. The driving wheel mount 62 has a driving member 622 respectively coupled to the driving wheel 64 and a motor 66 and a connecting member 624 pivoted to the first pivot portion 342 of the frame 30 and connected to the driving member 622 and having a curved limiting groove 626 for insertion of the limiting portion 322 of the lateral bar 32 of the frame 30. When the connecting member 624 of the driving wheel set 60 is pivoted about the first portion 342 of the frame 30, the connecting member 624 only can be pivoted within a predetermined angle due to the restriction of the limiting portion 322 of the lateral bar 32 of the frame 30. In other words, the pivoting angle of the connecting member 624 is determined by the length of the limiting groove 626 of the connecting member 624.

The second wheel sets 70 are rear wheel sets in this embodiment such that the driving wheel sets 60 are located between the first wheel sets 50 and the second wheel sets 70. Each second wheel set 70 comprises a second wheel mount 72 having a second wheel frame 724 and a second wheel tube 722 with two ends connected to a rear of the frame 30 and the second wheel frame 724, and a second wheel 74 rotatably mounted to the second wheel frame 724.

Each of the suspension devices 80 includes a cylinder 82, a piston 84, an adjusting member 86 and a compression spring 88. The cylinder 82, which includes an outer threaded section 822, has an end pivoted to the connecting member 624 of the driving wheel mount 62 of the driving wheel set 60. The piston 84 has an end pivoted to the first wheel tube 522 of the first wheel mount 52 of the first wheel set 50 and the other end inserted into the cylinder 82 to be moved relative to the cylinder 82. The adjusting member 86 is screwed onto the outer threaded section 822 of the cylinder 82 to be turned for movement upward and downward. The compression spring 88 has two ends stopping against the adjusting member 86 and the piston 84 to cushion a swing of the front wheel mount 52 and the driving mount 62 relative to the frame 30.

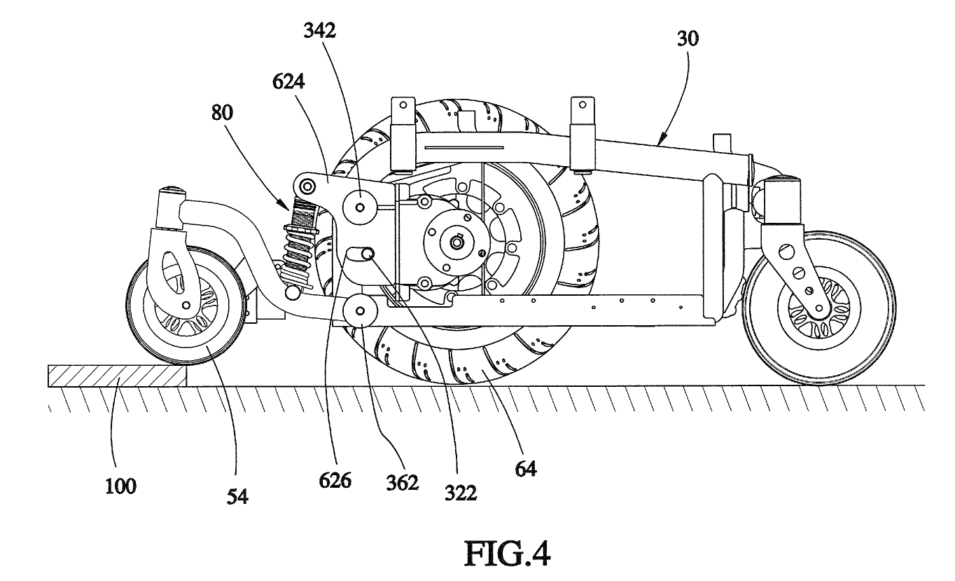

As shown in FIG. 4, when the power wheelchair 20 runs on a rough road and bumps with, for example a protrusion 100 as shown in the drawing, the front wheels 54 of the power wheelchair 20 will encounter the protrusion 100 first, and then run over the protrusion 100 because the power wheelchair 20 is continuously driven by the driving wheels 64 to move forwards, i.e., the front wheel mounts 52 of the front wheel sets 50 will be raised relative to the second pivot portions 362 of the frame 30 that are served as fulcrums to drive the front wheels 54 to climb over the protrusion 100. At the same time, the suspension devices 80 are raised to make the pistons 84 move into the cylinders 82 and compress the compression springs 88, thereby absorbing the impact received by the first wheels 54. Further, when the suspension devices 80 are raised, the connecting members 624 of the driving wheel sets 60 are pivoted upwardly relative to the first pivot portions 342 of the frame 30 that are served as fulcrums to make rear ends of the limiting grooves 626 of the connecting members 624 of the driving wheel sets 60 contact with the limiting portions 322 of the frame 30, thereby pressing the front wheels 54 on the ground to stabilize the power wheelchair 20.

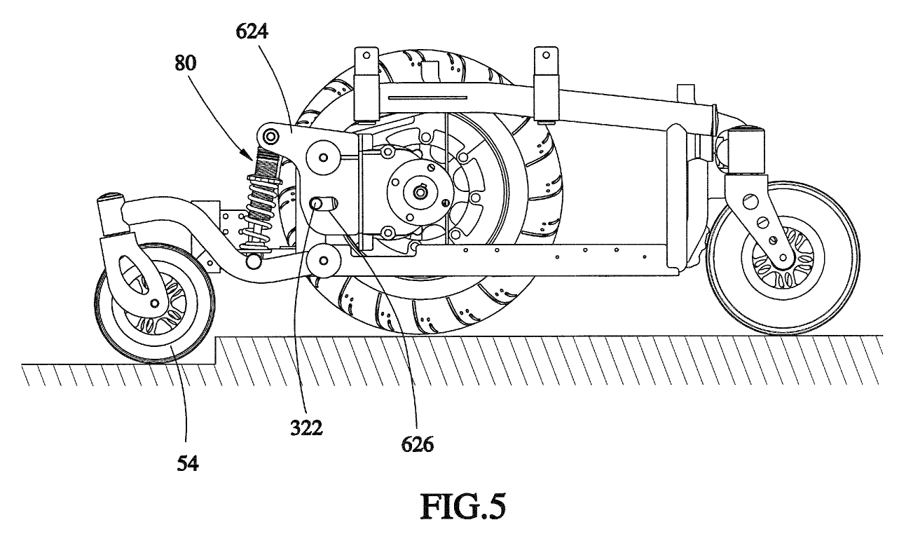

As shown in FIG. 5, when the power wheelchair 20 runs into a recess of a road, the front wheel mounts 52 of the power wheelchair 20 are pivoted downwardly, and the suspension devices 80 absorb the impact received by the first wheels 54 and drive the connecting members 624 of the driving wheel sets 60 to be pivoted downwardly such that front ends of the limiting grooves 626 of the connecting members 624 of the driving wheel sets 60 are contacted with the limiting portions 322 of the frame 30, thereby pressing the front wheels 54 on the ground to stabilize the power wheelchair 20.

In addition, when the user steps on the pedal 40 to leave the seat set 90 of the power wheelchair 20, the pedal 40 will bear the user's whole body weight and generate torque which may drive the second bar 36 of the frame 30 to rotate downwardly. Since the left and right sides of the frame 30 respectively have a pair of the first pivot portion 342 and second pivot portion 362, which are respectively formed of the distal ends of the first bar 34 and the second bar 36 of the frame 30, the torque generated by the pedal 40 can't drive the front of frame 30 to pivot about the two second pivot portions 362 of the frame 30. Accordingly, the user can leave safely the seat set 90 of the power wheelchair 20 without worrying that the seat set 90 may be overturned.

Furthermore, the above-mentioned embodiment of the invention includes three wheel sets, i.e. includes the first wheel sets, the driving wheel sets and the second wheel sets. However, in actual need, the power wheelchair can be equipped with two wheel sets, i.e. equipped with the first wheel sets and the driving wheel sets. Further, the first wheel sets can be the front wheel sets or the rear wheel sets of the power wheelchair having three wheel sets or two wheel sets.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. (canceled)

2. The power wheelchair as claimed in claim 11, wherein the frame has a lateral bar at each of the opposite sides thereof a first bar fixed on the lateral bars with two ends respectively protruding out from the lateral bars to form the first pivot portions of the frame, and a second bar fixed on the lateral bars with two ends respectively protruding out from the lateral bars to form the second pivot portions of the frame.

3. The power wheelchair as claimed in claim 2, wherein the first bar of the frame is located above the second bar of the frame; the driving wheel mounts of the driving wheel sets are pivoted to the ends of the first bar of the frame, and the first wheel mounts of the first wheel sets are pivoted to the ends of the second bar of the frame.

4. The power wheelchair as claimed in claim 3, wherein each of the driving wheel mounts of the driving wheel sets has a driving member fixed to a motor, and the connecting member on the first pivot portion.

5. The power wheelchair as claimed in claim 4, wherein the frame has two limiting projections respectively extending out from the lateral bars into a limiting groove provided on each of the connecting members.

6. The power wheelchair as claimed in claim 4, wherein each of the suspension devices has a cylinder with an end pivoted on the connecting member and a threaded section, a piston with an end pivoted to the first wheel tube and the other end inserted into the cylinder, an adjusting member threaded on the threaded section of the cylinder, and a compression spring with two opposite ends respectively abutted against the adjusting member and the piston.

7. The power wheelchair as claimed in claim 3, further comprising a pedal fixed on a middle part of the second bar of the frame.

8. The power wheelchair as claimed in claim 11, further comprising a pair of second wheel sets, each of which has a second wheel mount connected to one of opposite sides of a second end of the frame, and a second wheel rotatably connected to the second wheel mount; wherein the driving wheel sets are located between the first wheel sets and the second wheel sets.

9. The power wheelchair as claimed in claim 8, wherein the first wheels are front wheels and the driving wheels are middle wheels and the second wheels are rear wheels.

10. The power wheelchair as claimed in claim 11, further comprising a seat set mounted on a support bar of the frame.

11. A power wheelchair comprising:
A frame having first and second pivot portions fixed on each of opposite sides of a first end of the frame;
A pair of first wheel sets, each of which has a first wheel mount having an integrally formed wheel tube respectively pivoted on the second pivot portions fixed on the frame and a first wheel rotatably engaged on the wheel tube;
A pair of driving wheel sets, each of which has a driving wheel mount having an integrally formed connecting member respectively pivoted on the first pivot portions fixed on the frame and a driving wheel rotatably engaged to the driving wheel mount; and
A pair of suspension devices, each of which is respectively rotatably fixed on and between the wheel tube and the connecting member.
